(19) United States
(12) Patent Application Publication
(10) Pub. No.: US 2008/0094656 A1
(43) Pub. Date: Apr. 24, 2008

(54) DATA COMMUNICATION SYSTEM, DATA PROCESSING APPARATUS, FACSIMILE APPARATUS, DATA PROCESSING METHOD, AND STORAGE MEDIUM

(75) Inventor: Yuki Kusakabe, Kawasaki-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/873,306

(22) Filed: Oct. 16, 2007

(30) Foreign Application Priority Data
Oct. 23, 2006 (JP) 2006-288040

(51) Int. Cl. G06F 3/12

(52) U.S. Cl. 358/1.15

(57) ABSTRACT

In a data communication system including a facsimile apparatus having a function of creating data based on a facsimile signal, and a data processing apparatus that is connected to the facsimile apparatus via a network and does not have the function, the following processing is executed so that the data processing apparatus processes a facsimile signal. A telephone apparatus is connected to the data processing apparatus, and the data processing apparatus transforms the facsimile signal received by the telephone apparatus into a digital signal. The data processing apparatus transfers the digital signal to the facsimile apparatus. The facsimile apparatus transforms the received digital signal into print data and transfers it to the data processing apparatus. The data processing apparatus prints based on the received print data. Thus, a data processing apparatus having no function of creating data based on a facsimile signal can print images based on a facsimile signal.

### BACKGROUND OF THE INVENTION

1. Field of the Invention

The present invention relates to a facsimile technology.

2. Description of the Related Art

Conventionally, there is known a communication apparatus having a facsimile function which can connect to an existing communication line such as a public switched telephone network (PSTN). This type of communication apparatus has a function in which images read by a scanner are transmitted to a receiver via a public switched telephone network (PSTN) and the receiver which has received them outputs them on a recording sheet or stores them in a predetermined memory. In recent years, a multifunction peripheral-based facsimile apparatus having such function has prevailed. On the other hand, each individual often owns a single-function image forming apparatus as his or her own apparatus.

In general, a facsimile apparatus is connected by using a wired telephone line. In recent years, a cellular phone has become widespread, and it is possible to transmit/receive facsimile data anywhere by connecting a cellular phone (see Japanese Patent Laid-Open No. 06-301445).

However, in the conventional technology described above, an image forming apparatus receiving facsimile data needs a facsimile function as in a fax modem, i.e., a function of transmitting/receiving a facsimile signal and a function of interpreting the signal and reproducing the original image. If an image forming apparatus located near a user does not have a facsimile function, even if the user has a cellular phone, it is difficult to receive facsimile data nearby.

### SUMMARY OF THE INVENTION

The present invention has been made in consideration of the above problems, and has as its object to provide a technology which allows an apparatus to print out on the basis of a facsimile signal, even if the apparatus cannot print out on the basis of the facsimile signal.

To achieve the above objects, according to the first aspect of the present invention, there is provided an data communication system which includes a facsimile apparatus having a function of creating data on the basis of a facsimile signal, and a data processing apparatus that is connected to the facsimile apparatus via a network and has no function of creating data on the basis of a facsimile signal, wherein

the data processing apparatus comprises

a connection unit adapted to connect to a telephone apparatus,

a digital transformation unit adapted to transform an analog facsimile signal received by the telephone apparatus connected via the connection unit into a digital signal, and

a first transfer unit adapted to transfer the digital facsimile signal transformed by the digital transformation unit to the facsimile apparatus,

the facsimile apparatus comprises

a print data transformation unit adapted to transform the digital facsimile signal transferred by the first transfer unit into print data, and

a second transfer unit adapted to transfer the print data transformed by the print data transformation unit to the data processing apparatus, and

the data processing apparatus comprises a print unit adapted to print on the basis of the print data transferred by the second transfer unit.

According to the second aspect of the present invention, there is provided a data processing apparatus which is connected, via a network, to a facsimile apparatus having a function of creating data on the basis of a facsimile signal, comprising:

a connection unit adapted to connect to a telephone apparatus,

a digital transformation unit adapted to transform an analog facsimile signal received by the telephone apparatus connected via the connection unit into a digital signal,

a transfer unit adapted to transfer the digital facsimile signal transformed by the digital transformation unit to the facsimile apparatus,

a reception unit adapted to receive print data corresponding to the digital facsimile signal transferred by the transfer unit, and

a print unit adapted to print on the basis of the print data received by the reception unit.

### According to another aspect of the present invention, there is provided

According to the third aspect of the present invention, there is provided a facsimile apparatus which is connected, via a network, to a data processing apparatus having a function of connecting to a telephone line and a function of printing on the basis of print data, comprising:

a reception unit adapted to receive a digital facsimile signal corresponding to an analog facsimile signal received by the data processing apparatus through the telephone line,

a print data transformation unit adapted to transform the digital facsimile signal received by the reception unit into print data, and

a transfer unit adapted to transfer the print data transformed by the print data transformation unit to the data processing apparatus.

According to the fourth aspect of the present invention, there is provided a data processing method in a data communication system which includes a facsimile apparatus having a function of creating data on the basis of a facsimile signal, and a data processing apparatus that is connected to the facsimile apparatus via a network and has no function of creating data on the basis of a facsimile signal, wherein

the data processing apparatus transforms an analog facsimile signal received by a connected telephone apparatus into a digital signal, and transfers the transformed digital facsimile signal to the facsimile apparatus,

the facsimile apparatus transforms the digital facsimile signal transferred by the data processing apparatus into print data, and transfers the transformed print data to the data processing apparatus, and

the data processing apparatus prints on the basis of the print data transferred by the facsimile apparatus.

Further features of the present invention will become apparent from the following description of exemplary embodiments with reference to the attached drawings.

### BRIEF DESCRIPTION OF THE DRAWINGS

FIG. 1 is a view showing the schematic configuration of a system according to an embodiment of the present invention;

FIG. 2 is a block diagram showing the hardware configuration of a facsimile apparatus 101;

FIG. 3 is a block diagram showing the hardware configuration of a cellular phone 103;

FIG. 4 is a block diagram showing the hardware configuration of an image forming apparatus 105;

FIG. 5 is a block diagram showing the hardware configuration of an image forming apparatus 107;

FIG. 6 is a flowchart showing processes performed by the facsimile apparatus 101, cellular phone 103, and image forming apparatuses 105 and 107;

FIG. 7 is a block diagram showing the functional configurations of apparatuses associated with the processes which are executed from when the facsimile apparatus 101 generates a FAX signal until the image forming apparatus 107 forms an image; and

FIG. 8 is a block diagram showing the functional configurations of the image forming apparatuses 105 and 107 associated with an image print process performed by the image forming apparatus 105.

### DESCRIPTION OF THE EMBODIMENTS

With reference to the accompanying drawings, the present invention will be described in detail below in accordance with the preferred embodiments.

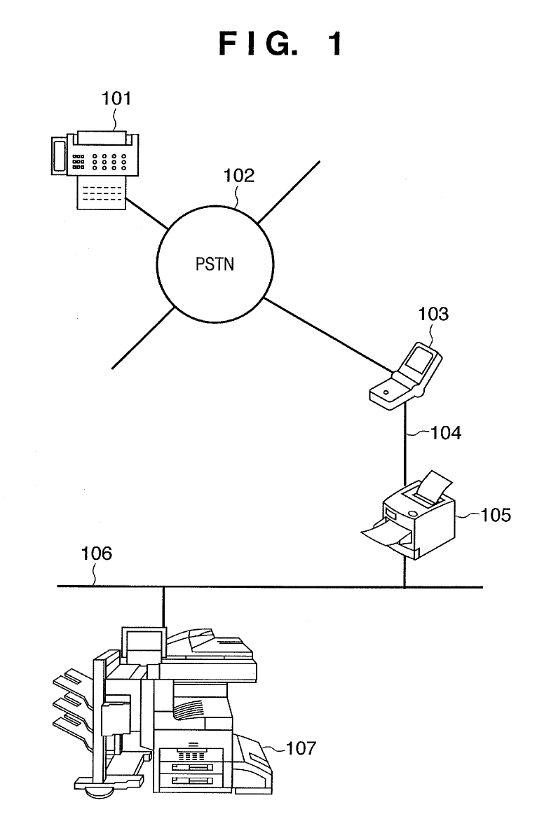

FIG. 1 is a view showing the schematic configuration of a system according to an embodiment. As shown in FIG. 1, the system according to the embodiment comprises a facsimile apparatus 101, cellular phone 103, and image forming apparatuses 105 and 107.

The facsimile apparatus 101 and the cellular phone 103 are connected to a public switched telephone network (PSTN) 102, and are configured to be able to communicate data with each other through the PSTN 102.

The cellular phone 103 is further connected to the image forming apparatus 105 through a coupler/cellular line 104. The image forming apparatus 105 does not have a function (to be referred to as a FAX function hereinafter) of interpreting and transmitting/receiving a procedure signal and reproducing images on the basis of the facsimile signal in a facsimile modem or a facsimile apparatus.

The image forming apparatus 105 is connected to a local area network (LAN) 106 and the image forming apparatus 107 having a FAX function is also connected on the LAN 106.

A case in which, with a system having the above-mentioned configuration, the image forming apparatus 105 prints out on the basis of a facsimile signal generated by the facsimile apparatus 101 will now be explained.

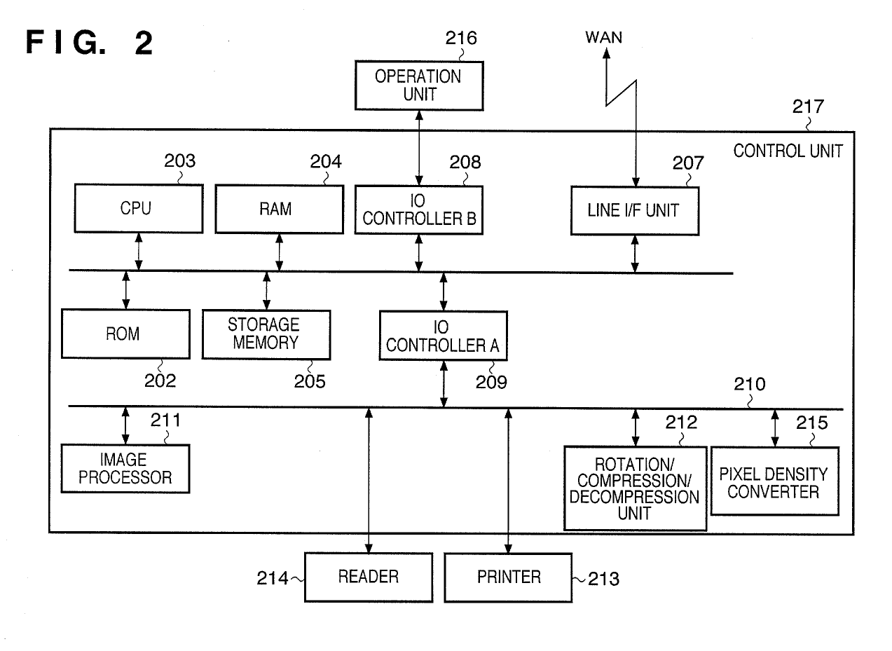

FIG. 2 is a block diagram showing the hardware configuration of the facsimile apparatus 101. As shown in FIG. 2, the facsimile apparatus 101 comprises a control unit 217, operation unit 216, reader 214, and printer 213.

The control unit 217 mainly controls the operations of the units constituting the apparatus. The operation unit 216 is used to input various operation instructions to the apparatus and has a display unit for displaying various pieces of information. The operation unit 216 comprises, e.g., a touch panel. The reader 214 reads information recorded on a recording medium such as a paper sheet. The printer 213 records, on a recording medium such as a paper sheet, information based on data designated to be printed.

Components constituting the control unit 217 will now be described. A CPU 203 controls operations of the units constituting the apparatus by executing processing using programs and data stored in a ROM 202.

A RAM 204 can provide an area for temporarily storing the programs and data which are loaded from the ROM 202, an area for temporarily storing the data which are being processed, a work area used by the CPU 203 for performing various processes, and the like, as needed.

The ROM 202 stores a boot program, and operation control programs and data of the apparatus. Some of such programs and data may be stored in a storage memory 205. The storage memory 205 stores facsimile code data, image data, system software and the like.

A line I/F unit 207 connects the apparatus to the PSTN 102. The apparatus communicates data with the cellular phone 103 through the line I/F unit 207. Note that the line I/F unit 207 may be configured to be able to connect to ISDN. In either case, the CPU 203 executes the control programs stored in the ROM 202 to control the line I/F unit 207. The line I/F unit 207 can transmit/receive data to/from a remote apparatus through an ISDN I/F, modem, or NCU (Network Control Unit). In addition, the line I/F unit 207 has a function of performing compression/decompression processing on image data.

An TO controller B 208 connects the operation unit 216 to the control unit 217. The CPU 203 receives, through the IO controller B 208, operation instructions which are input by operating the operation unit 216. Furthermore, a signal indicating display content to be displayed on the screen of the operation unit 216 is sent to the operation unit 216 through the IO controller B 208.

The above-described components of the control unit 217 are connected to a system bus 201.

An IO controller A 209 connects the system bus 201 and an image bus 210 which transfers image data at high speed. With this configuration, the component units which are connected to the system bus 201 can communicate, through the IO controller A 209, data with the component units which are connected to the image bus 210. Note that when transferring data which is received from one bus to the other bus, the IO controller A 209 functions as a bus bridge which transforms the data structure.

The image bus 210 comprises a PCI bus or IEEE 1394. A component unit group (to be described below) is connected to the image bus 210.

On the received image data through the reader 214 or the line I/F unit 207, an image processor 211 performs processing such as correction, modification, or edit. A rotation/compression/decompression unit 212 executes compression/decompression processing such as rotation, compression/decompression, binary/multi-valued data conversion, JPEG, JBIG, MR or MMR for the image data. A pixel density converter 215 performs pixel density conversion processing of the image data.

Note that the configuration of the facsimile apparatus 101 is not limited to that shown in FIG. 1 as long as it is capable of communication in accordance with a transmitting/receiving method for a G3 FAX which is defined in ITU-T T.30. The apparatus may be a G4 FAX using ISDN other than a G3 FAX.

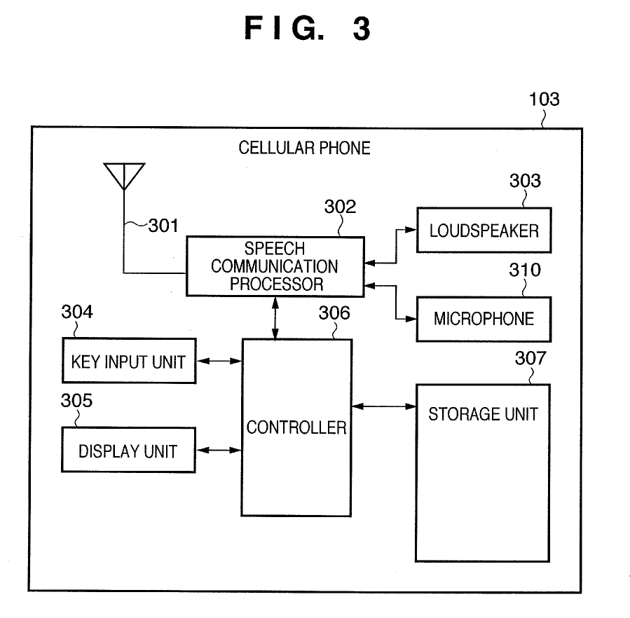

FIG. 3 is a block diagram showing the hardware configuration of the cellular phone 103.

Reference numeral 301 denotes an antenna unit which transmits/receives radio waves to/from a radio base station for communicating with PSTN 102. That is, the antenna unit 301 sends, to a speech communication processor 302 as a signal, radio waves received from the radio base station connected to the PSTN 102, and also sends radio waves based on a signal received from the speech communication processor 302 to the radio base station.

When the antenna unit 301 receives, from the radio base station, radio waves based on a signal output from the PSTN 102, and sends a signal based on the radio waves to the speech communication processor 302, the speech communication processor 302 transforms the signal into an audible signal and sends it to a loudspeaker 303. The loudspeaker 303 outputs voice based on the audible signal.

In this embodiment, the cellular phone 103 has a terminal for externally outputting the audible signal output to the loudspeaker 303. The coupler/cellular line 104 is connected to the terminal. The audible signal is, therefore, sent to the image forming apparatus 105 through the terminal and the coupler/cellular line 104. Note that the audible signal does not output through the terminal, but the voice output from the loudspeaker may be directly output to the coupler/cellular line 104.

On the other hand, when an audible signal is input through a microphone 310, the speech communication processor 302 sends the audible signal to the antenna unit 301. With this operation, the antenna unit 301 sends radio waves based on the audible signal to the radio base station, and then the radio base station sends them to the PSTN 102.

A key input unit 304 comprises a button group including dial buttons, and can be used to input various instructions to a controller 306. A display unit 305 comprises, e.g., a liquid crystal screen, and can display the result of the processing by the controller 306 with images and texts.

The controller 306 controls the operations of the speech communication processor 302 and the display unit 305, and performs processing corresponding to the instruction input from the key input unit 304. A storage unit 307 stores programs and data for causing the controller 306 to execute various processes of the apparatus, and temporarily records data which are being processed.

The configuration of the cellular phone 103 is not limited to that shown in FIG. 3 as long as it is possible to communicate data with the facsimile apparatus 101 through the PSTN 102 and to communicate with the image forming apparatus 105 through the coupler/cellular line 104.

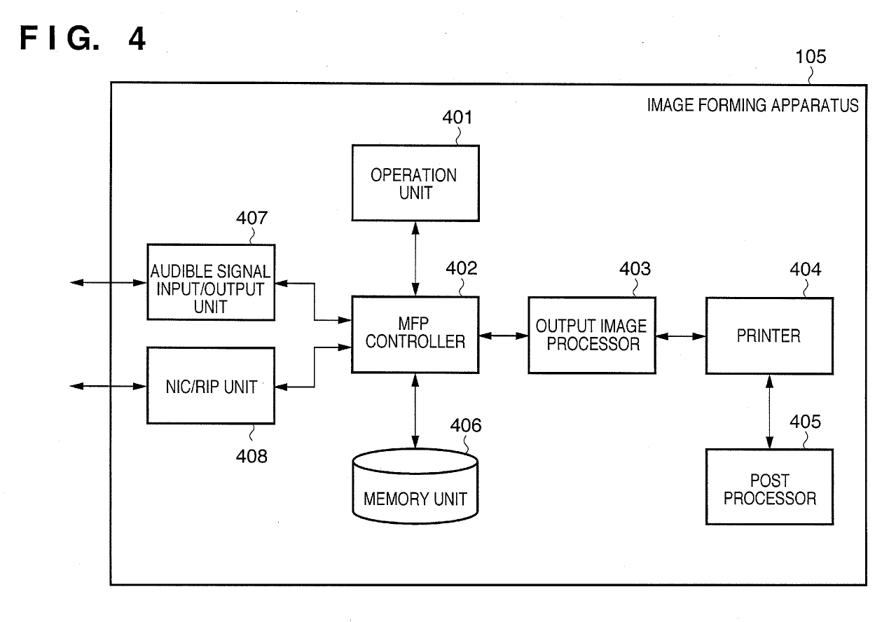

FIG. 4 is a block diagram showing the hardware configuration of the image forming apparatus 105.

When the cellular phone 103 sends an audible signal (analog signal) through the coupler/cellular line 104, an audible signal input/output unit 407 transforms the analog signal into a digital signal, and sends it to the image forming apparatus 107 via the LAN 106. Also, the audible signal input/output unit 407 receives a digitalized audible signal, transforms it into an analog signal, and outputs it to the cellular phone 103 through the coupler/cellular line 104.

A NIC (Network Interface Card)/RIP unit 408 has a NIC unit which communicates data with the image forming apparatus 107 connected on the LAN 106. The NIC unit transfers, to an MFP controller 402, image data received from the image forming apparatus 107 via the LAN 106.

The NIC/RIP unit 408 also includes a RIP unit. The RIP unit interprets the image data (mainly, PDL (Page Description Language) data) received at the NIC unit from the image forming apparatus 107, and RIP (Raster Image Processor)-rasterizes it.

The MFP controller 402 controls the whole apparatus by using programs and data recorded on its own memory (not shown) and data held in a memory unit 406, and controls the operations of units constituting the apparatus.

The memory unit 406 temporarily stores the image data received at the NIC/RIP unit 408 from the image forming apparatus 107, and the like.

An output image processor 403 processes the image data which are designated to be printed by the MFP controller 402, so as to transform the image data into data of data format printable by a printer 404. After that, the output image processor 403 executes processing of transferring the processed data to the printer 404. The printer 404 feeds sheets, and forms the images based on the transferred data on those sheets. The sheets printed out are sent to a post processor 405. The post processor 405 performs a sheet sorting process and a finishing process.

An operation unit 401 comprises a button group and a display screen. An operator of the apparatus can operate the operation unit 401 to input various instructions to the MFP controller 402. The operation unit 401 can display the result of the processing by the MFP controller 402.

The configuration of the image forming apparatus 105 is not limited to this as long as the configuration has a function of receiving an audible signal and externally sending it as a digital signal, and has a function of receiving image data and printing it out on a recording medium such as a paper sheet.

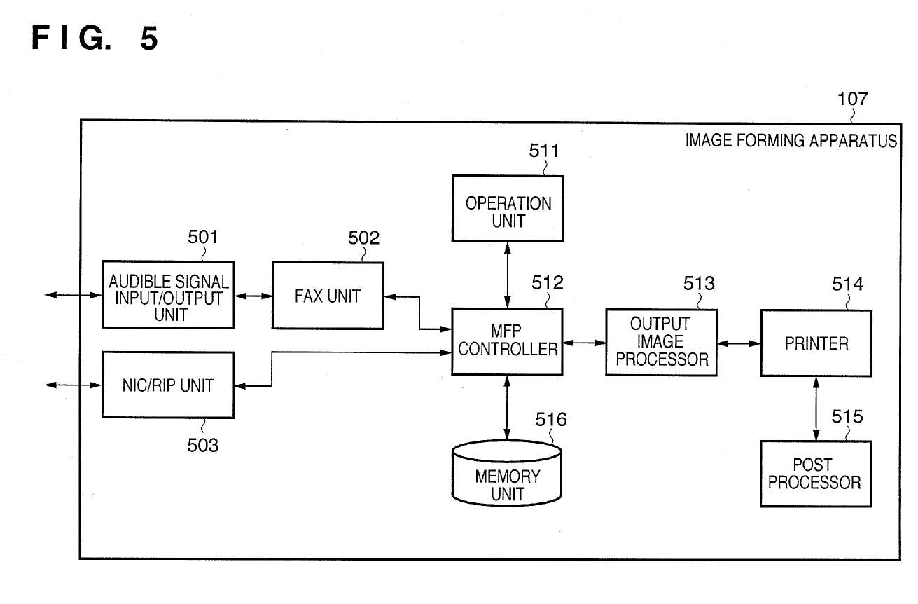

FIG. 5 is a block diagram showing the hardware configuration of the image forming apparatus 107. Upon receiving a digital signal sent from the image forming apparatus 105 via the LAN 106, an audible signal input/output unit 501 transforms the digital signal into an analog signal and transfers it to a FAX unit 502. The FAX unit 502 is a facsimile communication unit which has an NCU (Network Control Unit), encoder, decoder, and modem. The FAX unit 502 creates image data on the basis of the analog facsimile signal received from the audible signal input/output unit 501, and transfers it to an MFP controller 512.

A NIC (Network Interface Card)/RIP unit 503 has a NIC unit which communicates data with the image forming apparatus 105 connected on the LAN 106. For example, the NIC unit transforms the image data, which is transferred from the FAX unit 502 to the MFP controller 512, into a predetermined type of PDL data, and transfers it to the image forming apparatus 105 via the LAN 106.

The NIC/RIP unit 503 also includes a RIP unit. The RIP unit interprets the image data (mainly, PDL (Page Description Language) data) received at the NIC unit from the apparatus on the LAN 106 and the image data transferred from the FAX unit 502 to the MFP controller 512. The RIP unit RIP (Raster Image Processor)-rasterizes the interpreted data.

The MFP controller 512 controls the whole apparatus by using programs and data recorded on its own memory (not shown) and data held in a memory unit 516, and controls the operations of units constituting the apparatus.

The memory unit 516 temporarily stores the image data transferred from the FAX unit 502 to the MFP controller 512, and the like.

An output image processor 513 processes the image data which are designated to be printed by the MFP controller 512, so as to transform the image data into data of a data format printable by a printer 514. After that, the output image processor 513 executes processing which transfers the processed data to the printer 514. The printer 514 feeds sheets, and forms the images based on the transferred data on those sheets. The sheets printed out are sent to a post processor 515. The post processor 515 performs a sheet sorting process and a finishing process.

An operation unit 511 comprises a button group and a display screen. An operator of the apparatus can operate the operation unit 511 to input various instructions to the MFP controller 512. The operation unit 511 can display the result of the processing by the MFP controller 512.

The hardware configuration of the image forming apparatus 107 is not limited to that shown in FIG. 5 as long as it is possible to create image data on the basis of a digital facsimile signal received from the image forming apparatus 105 and to return it to the image forming apparatus 105.

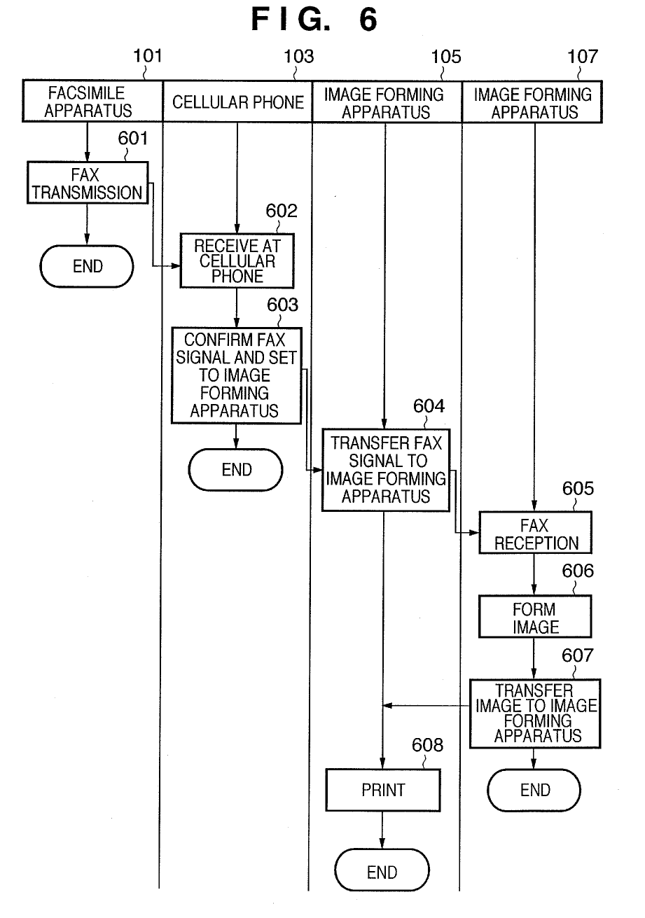

Processing which causes the image forming apparatus 105 to print out an image based on a FAX signal transmitted from the facsimile apparatus 101 to the cellular phone 103 will now be explained. FIG. 6 is a flowchart showing processes performed by the facsimile apparatus 101, cellular phone 103, and image forming apparatuses 105 and 107 in order to execute such processing. In this specification, a processing example using a G3 FAX complying with ITU-T T.30 will be described.

An operation control program corresponding to step S601 is stored in the ROM 202. This operation control program is loaded to the RAM 204 under the control of the CPU 203, as needed. The CPU 203 controls the operations of units constituting the facsimile apparatus 101 by using the loaded operation control program. Thus, the facsimile apparatus 101 executes the process corresponding to step S601.

An operation control program corresponding to steps S602 and S603 is stored in a memory (not shown) of the controller 306. The controller 306 controls the operations of units constituting the cellular phone 103 by using the loaded operation control program. Thus, the cellular phone 103 performs the processes corresponding to steps S602 and S603.

An operation control program corresponding to steps S604 and S608 is stored in a memory (not shown) of the MFP controller 402. The MFP controller 402 controls the operations of units constituting the image forming apparatus 105 by using the loaded operation control program. Thus, the image forming apparatus 105 executes the processes corresponding to steps S604 and S608.

An operation control program corresponding to steps S605 to S607 is stored in a memory (not shown) of the MFP controller 512. The MFP controller 512 controls the operations of units constituting the image forming apparatus 107 by using the loaded operation control program. Thus, the image forming apparatus 107 performs the processes corresponding to steps S605 to S607.

An operator of the facsimile apparatus 101 uses the operation unit 216 to input an instruction which causes the reader 214 to read an image on a document which he/she wants to send with FAX. At this time, by using the operation unit 216, the operator of the facsimile apparatus 101 inputs the telephone number of the cellular phone 103, selects a resolution and density in reading the document, and then issues a transmission start instruction. After this input operation, the CPU 203 controls the reader 214 to read the image on the document in step S601. Furthermore, in step S601, the CPU 203 originates a call to transmit, through the line I/F unit 207, a FAX signal indicating the result of the read operation to the cellular phone 103 connected to the PSTN 102. In step S602, a radio base station located near the cellular phone 103 sends a ring signal to the cellular phone 103. An operator of the cellular phone 103 performs a line connecting operation by using the key input unit 304. In this manner, transmission of a FAX signal starts. This FAX signal is transmitted to the cellular phone 103 via the PSTN 102 and the radio base station in the form of radio waves.

In step S602, when the operator performs the line connecting operation by using the key input unit 304, the antenna unit 301 of the cellular phone 103 receives the radio waves corresponding to the transmitted FAX signal, and sends them as a signal to the speech communication processor 302. In step S603, since the signal from the speech communication processor 302 is output to the microphone 310 and the operator of the cellular phone 103 hears, e.g., a CNG signal indicating a FAX signal, the operator can recognize the reception of the FAX signal. When the operator connects the cellular phone 103 to the coupler/cellular line 104, the speech communication processor 302 sends the signal to the image forming apparatus 105 through the coupler/cellular line 104. At this time, the operator operates the operation unit 401 of the image forming apparatus 105 to instruct to execute a FAX reception process. With this operation, the image forming apparatus 105 (the MFP controller 402) acknowledges the reception of the FAX signal, and executes the processes in step S604 and thereafter. Note that the processes in step S604 and thereafter may be automatically performed by detecting the input of an audible signal from the coupler/cellular line 104, without the operation of the operation unit 401.

In step S604, on the image forming apparatus 105 side, the audible signal input/output unit 407 receives the analog signal transmitted from the cellular phone 103 in step S603, and transforms it into a digital signal. Furthermore, in step S604, the audible signal input/output unit 407 transmits the digital signal to the image forming apparatus 107 via the LAN 106. Note that the image forming apparatus 105 also transmits its own network address (IP address) on the LAN 106 to the image forming apparatus 107 via the LAN 106 in step S604. The image forming apparatus 105 simultaneously transmits the telephone number of the cellular phone 103, information about a recording sheet size printable by the printer 404 (print capability), and the like to the image forming apparatus 107 via the LAN 106.

Upon reception of the information such as the information indicating the FAX reception from the image forming apparatus 105, the network address, the telephone number of the cellular phone 103, and the recording sheet size printable by the printer, the image forming apparatus 107 generates a response signal to the facsimile apparatus 101. That is, the image forming apparatus 107 sets the telephone number of the cellular phone 103 in a CSI signal, and sets information about a recording sheet size printable by the printer 404 in recording sheet size information of a DIS signal. For other information of the DIS signal, preset information in the image forming apparatus 107 is used. Note that information indicating that collaborated processing between the image forming apparatuses 105 and 107 according to the embodiment is executed may be set to an NSF signal.

The NSF/CSI/DIS signals thus generated are transmitted to the image forming apparatus 105 via the LAN 106 on the basis of the network address. The image forming apparatus 105 which has received the signals transforms them into analog signals. The cellular phone 103 transmits the analog signals to the facsimile apparatus 101 through the coupler/cellular line 104.

The facsimile apparatus 101 returns NSS/TSI/DCS signals. The image forming apparatus 105 transforms the analog signals into digital signals, and transmits them to the image forming apparatus 107. Thereafter, facsimile communication is executed through the facsimile apparatus 101, cellular phone 103, and image forming apparatuses 105 and 107 in accordance with the known G3 FAX procedure.

With the above-mentioned procedure, in the image forming apparatus 107, when receiving the digital signal corresponding to a facsimile image, the audible signal input/output unit 501 transforms the digital signal into an analog signal and then sends it to the FAX unit 502 in step S605. In step S606, the FAX unit 502 reproduces the image data transmitted by the facsimile apparatus 101 on the basis of the analog signal. Furthermore, in step S606, the output image processor 513 transforms the image data into image data of a PDL format. This image data may be transformed into any format as long as it can be processed on the image forming apparatus 105 side. The formed image data is temporarily stored in the memory unit 516. When the image forming apparatus 107 successfully receives the FAX signal corresponding to the FAX image digitized by the image forming apparatus 105, the image forming apparatus 105 terminates the communication with the facsimile apparatus 101 via the PSTN 102 by executing an end procedure of FAX.

In step S607, the image forming apparatus 107 refers to the network address, which is transmitted from the image forming apparatus 105 in step S604, to identify the transmission destination of the image data. In this case, since the network address corresponds to the image forming apparatus 105, the NIC/RIP unit 503 transmits the image data, which the MFP controller 512 reads out from the memory unit 516, to the image forming apparatus 105 via the LAN 106.

As described above, in place of the network address, any information may be transmitted as long as the image forming apparatus 107 can identify, with that information, the transmission destination of the image data created on the image forming apparatus 107 side. In place of the network address of the image forming apparatus 105, the network addresses of other apparatuses may be transmitted to the image forming apparatus 107.

In step S608, on the image forming apparatus 105 side, when receiving the image data, the NIC/RIP unit 408 temporarily stores the image data in the memory unit 406 under the control of the MFP controller 402. In step S608, on the image data stored in the memory unit 406, the output image processor 403 performs a process of transforming data into a data format printable by the printer 404. The output image processor 403 then transfers the processed data to the printer 404.

Furthermore, in step S608, the printer 404 feeds sheets, and forms images based on the transferred data on those sheets. The sheets printed out are sent to the post processor 405. The post processor 405 executes a sheet sorting process and a finishing process.

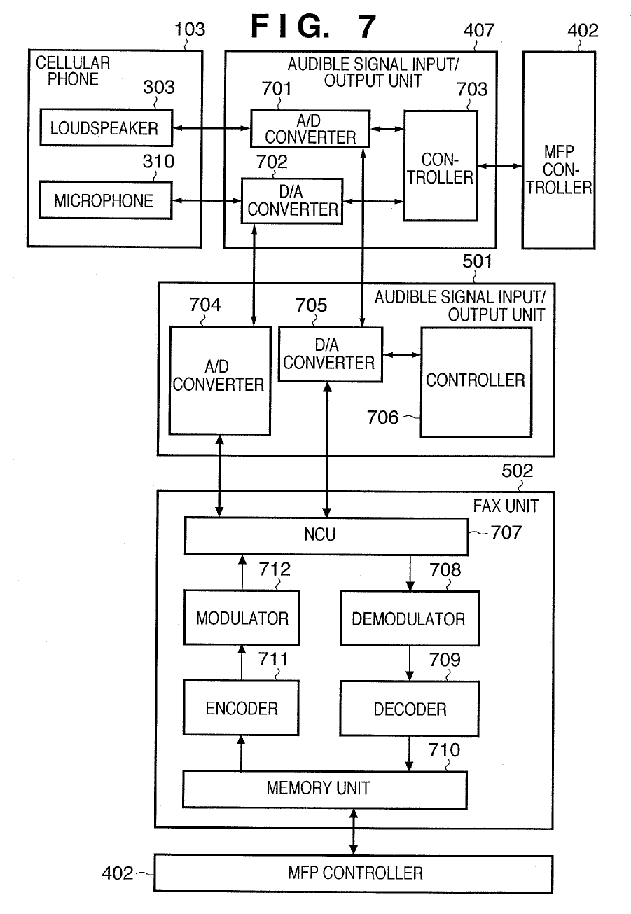

FIG. 7 is a block diagram showing the functional configurations of apparatuses involved in the processes which are executed from when the facsimile apparatus 101 issues a FAX signal until the image forming apparatus 107 forms an image.

An A/D converter 701 of the audible signal input/output unit 407 converts, into a digital signal, a signal sent from the loudspeaker 303 of the cellular phone 103 to the audible signal input/output unit 407 of the image forming apparatus 105. A controller 703 of the audible signal input/output unit 407 transfers the digital signal to the audible signal input/output unit 501 of the image forming apparatus 107. At the same time, the image forming apparatus 105 transmits its own network address on the LAN 106, print capability, and the telephone number of the cellular phone 103 to the image forming apparatus 107.

Upon reception of the digital signal, a D/A converter 705 of the audible signal input/output unit 501 in the image forming apparatus 107 converts the digital signal into an analog signal. The D/A converter 705 sends the converted analog signal to an NCU (Network Control Unit) 707 of the FAX unit 502 in the image forming apparatus 107.

The NCU 707 which has received the analog signal from the D/A converter 705 converts it into a digital signal in the same way as for the facsimile reception, and transforms the voltage of the converted digital signal. The digital signal is sent to a demodulator 708. The demodulator 708 executes an A/D conversion process called demodulation for the digital signal. The converted digital signal is input to a decoder 709. The decoder 709 rasterizes the data (compressed data such as run-length data) indicated by the digital signal into raster data. The image rasterized into the raster data is temporarily stored in a memory unit 710 of the FAX unit 502. After the MFP controller 512 confirms that there is no transfer error in the image data, the image data is sent out to the MFP controller 402 of the image forming apparatus 105.

The FAX unit 502 generates a procedure signal to be exchanged with the facsimile apparatus 101 in the FAX communication procedure. The A/D converter 704 then converts the signal into a digital signal, and transfers it to the image forming apparatus 105. In the image forming apparatus 105, a D/A converter 702 coverts the digital signal into an analog signal, and outputs it to the cellular phone 103. With this operation, facsimile communication with the facsimile apparatus 101 is established. As for the print capability exchanged with the facsimile apparatus 101, the facsimile apparatus 101 is informed of the print capability of the image forming apparatus 105 rather than that of the image forming apparatus 107. The facsimile apparatus 101, therefore, transmits image data printable by the image forming apparatus 105. Since the telephone number of the cellular phone 103 is set to the procedure signal, there is no possibility that the telephone number which the facsimile apparatus 101 dials is different from that of an actual communication partner. The FAX unit 502 can use, without any process, the print capability which the image forming apparatus 107 uses for facsimile communication through the PSTN.

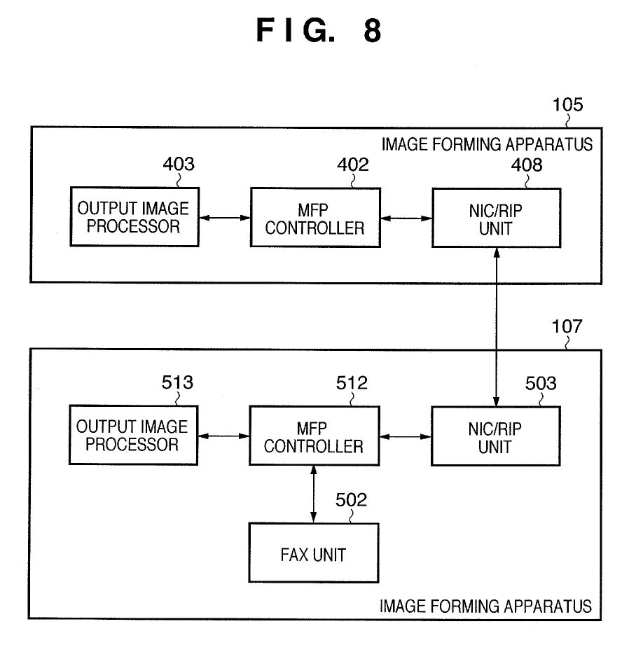

FIG. 8 is a block diagram showing the functional configurations of the image forming apparatuses 105 and 107 associated with an image print process performed by the image forming apparatus 105.

As described above, upon reception of a facsimile signal, the image forming apparatus 105 sends a signal together with its own network address to the image forming apparatus 107. For example, an IP address and friendly name of the image forming apparatus 105 are used as the network address. However, the network address is not limited to them.

After the FAX unit 502 of the image forming apparatus 107 creates image data, the output image processor 513 transforms the created image data into image data of a PDL format. The NIC/RIP unit 503 sends the transformed image data to the NIC/RIP unit 408 of the image forming apparatus 105 under the control of the MFP controller 512. At the image forming apparatus 105 side, the output image processor 403 processes the image data to transform the data into data of a data format printable by the printer 404. The output image processor 403 transfers the processed data to the printer 404.

As explained above, according to this embodiment, an image forming apparatus having no FAX function can use a FAX function by connecting to an image forming apparatus having a FAX function.

<Modification>

When a plurality of image forming apparatuses having a FAX function are connected to the LAN 106, the image forming apparatus 105 may be configured to select which image forming apparatus processes a FAX signal before transferring the FAX signal. In this case, the image forming apparatus 105 lists the names of the image forming apparatuses connected to the LAN 106 on the display screen of the operation unit 401, and waits for a selection instruction from an operator.

When the operator selects one of the listed apparatuses, the image forming apparatus 105 transfers the FAX signal received via the cellular phone 103 to the selected image forming apparatus. The image forming apparatus 105 obtains the network addresses of the plurality of image forming apparatuses in advance. The image forming apparatus 105 transmits the FAX signal to the selected image forming apparatus by using its network address. The remaining processes are the same as those described above.

In the above description, the cellular phone 103 receives a FAX signal. However, the present invention is not limited to this. A fixed phone may receive the FAX signal and input an audible signal via a coupler in the same way as for the cellular phone. The image forming apparatus 105 may have a telephone function to receive and transmit an audible signal. Furthermore, the image forming apparatus 105 may have a FAX function. In this case, if the image forming apparatus 107 has an advanced FAX function (e.g., a color FAX function), the image forming apparatus 105 can advantageously use the advanced FAX function.

According to the embodiment described above, an image forming apparatus having no FAX function can print images received by FAX. By establishing such system, it is possible to share a FAX function of one apparatus between a plurality of apparatuses.

### Other Embodiments

The objects of the present invention are also achieved as follows. That is, a recording medium (or storage medium), which records a program code of a software program that implements the functions of the above-mentioned embodiments, is supplies to a system or apparatus. A computer (or a CPU or MPU) of the system or apparatus reads out and executes the program code stored in the recording medium. In this case, the program code itself read out from the recording medium implements the functions of the above-mentioned embodiments, and the recording medium which records the program code constitutes the present invention.

When the computer executes the readout program code, an operating system (OS) or the like running on the computer executes some or all of actual processes on the basis of an instruction of the program code. The present invention includes a case wherein the functions of the above-mentioned embodiments are implemented by these processes.

Furthermore, assume that the program code read out from the recording medium is written in the memory of a function expansion card inserted into the computer or the memory of a function expansion unit connected to the computer. The present invention also includes a case wherein the functions of the above-mentioned embodiments are implemented when a CPU or the like arranged in the expansion card or unit executes some or all of actual processes on the basis of an instruction of the program code.

When the present invention is applied to the recording medium, that recording medium stores program codes corresponding to the aforementioned flowcharts.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-288040 filed Oct. 23, 2006 which is hereby incorporated by reference herein in its entirety.

What is claimed is:

1. A data communication system which includes a facsimile apparatus having a function of creating data on the basis of a facsimile signal, and a data processing apparatus that is connected to the facsimile apparatus via a network and has no function of creating data on the basis of a facsimile signal, wherein
the data processing apparatus comprises
a connection unit adapted to connect to a telephone apparatus,
a digital transformation unit adapted to transform an analog facsimile signal received by the telephone apparatus connected via said connection unit into a digital signal, and
a first transfer unit adapted to transfer the digital facsimile signal transformed by said digital transformation unit to the facsimile apparatus,
the facsimile apparatus comprises
a print data transformation unit adapted to transform the digital facsimile signal transferred by said first transfer unit into print data, and
a second transfer unit adapted to transfer the print data transformed by said print data transformation unit to the data processing apparatus, and
the data processing apparatus comprises a print unit adapted to print on the basis of the print data transferred by said second transfer unit.

2. The system according to claim 1, wherein
the facsimile apparatus further comprises a generation unit adapted to generate, as a digital signal, a response signal for the digital facsimile signal transferred by said first transfer unit,
said second transfer unit transfers the response signal generated by said generation unit to the data processing apparatus, and
the data processing apparatus further comprises
an analog transformation unit adapted to transform the response signal transferred by said second transfer unit into an analog signal, and
an output unit adapted to output, to the telephone apparatus connected via said connection unit, the response signal transformed into the analog signal by said analog transformation unit.

3. The system according to claim 2, wherein said generation unit generates a response signal to inform said facsimile apparatus as a source of a print function of said print unit.

4. A data processing apparatus which is connected, via a network, to a facsimile apparatus having a function of creating data on the basis of a facsimile signal, comprising:
a connection unit adapted to connect to a telephone apparatus,
a digital transformation unit adapted to transform an analog facsimile signal received by the telephone apparatus connected via said connection unit into a digital signal,
a transfer unit adapted to transfer the digital facsimile signal transformed by said digital transformation unit to the facsimile apparatus,
a reception unit adapted to receive print data corresponding to the digital facsimile signal transferred by said transfer unit, and
a print unit adapted to print on the basis of the print data received by said reception unit.

5. A computer-readable storage medium which stores a program for causing a computer to function as units constituting the data processing apparatus defined in claim 4.

6. A facsimile apparatus which is connected, via a network, to a data processing apparatus having a function of connecting to a telephone line and a function of printing on the basis of print data, comprising:
a reception unit adapted to receive a digital facsimile signal corresponding to an analog facsimile signal received by the data processing apparatus through the telephone line,
a print data transformation unit adapted to transform the digital facsimile signal received by said reception unit into print data, and
a transfer unit adapted to transfer the print data transformed by said print data transformation unit to the data processing apparatus.

7. A computer-readable storage medium which stores a program for causing a computer to function as units constituting the facsimile apparatus defined in claim 6.

8. A data processing method in a data communication system which includes a facsimile apparatus having a function of creating data on the basis of a facsimile signal, and a data processing apparatus that is connected to the facsimile apparatus via a network and has no function of creating data on the basis of a facsimile signal, wherein
the data processing apparatus transforms an analog facsimile signal received by a connected telephone apparatus into a digital signal, and transfers the transformed digital facsimile signal to the facsimile apparatus,
the facsimile apparatus transforms the digital facsimile signal transferred by the data processing apparatus into print data, and transfers the transformed print data to the data processing apparatus, and
the data processing apparatus prints on the basis of the print data transferred by the facsimile apparatus.
